(19) United States
(12) Patent Application Publication
(10) Pub. No.: US 2023/0059162 A1
(43) Pub. Date: Feb. 23, 2023

(54) SYSTEM FOR PROCESSING MACHINE LEARNING, APPARATUS AND METHOD FOR DETERMINING NUMBER OF LOCAL PARAMETERS

(71) Applicant: Korea University Research And Business Foundation, Seoul (KR)

(72) Inventors: Sangheon PACK, Seoul (KR); Ho-Chan LEE, Seoul (KR); HeeWon KIM, Goyang-si (KR); Haneul KO, Sejong-si (KR)

(73) Assignee: Korea University Research And Business Foundation, Seoul (KR)

(21) Appl. No.: 17/888,843

(22) Filed: Aug. 16, 2022

(30) Foreign Application Priority Data
Aug. 17, 2021 (KR) 10-2021-0108084

(51) Int. Cl. G06N 20/00

(52) U.S. Cl. CPC G06N 20/00

(57) ABSTRACT

Provided are a learning processing system, and an apparatus and method for determining a number of local parameters. A method of determining a number of local parameters may include receiving a number of local parameters less than or equal to a number of local parameters to be aggregated from at least one distributed learning processing apparatus; acquiring a T-th global parameter using the number of local parameters less than or equal to the number of local parameters to be aggregated; and updating or maintaining the number of local parameters to be aggregated depending on whether signs are different between a (T−1)-th global parameter and the T-th global parameter.

### CROSS-REFERENCE TO RELATED APPLICATIONS

This application claims the benefit under 35 USC § 119(a) of Korean Patent Application No. 10-2021-0108084 filed on Aug. 17, 2021 in the Korean Intellectual Property Office, the entire disclosure of which is incorporated herein by reference for all purposes.

### BACKGROUND

### 1. Field

At least one example embodiment relates to a learning processing system, and an apparatus and method for determining a number of local parameters.

### 2. Description of Related Art

Machine learning refers to technology in which a computer device acquires and updates an algorithm through self-learning using a large amount of data and acquires a result corresponding to input data using the acquired algorithm. Machine learning is in spotlight since it is possible to relatively easily and accurately implement a complex determination or a classification algorithm. In particular, with the recent development of information processing technology and development of various learning techniques, machine learning is further growing and being employed and used in various fields. Deep learning is a type of machine learning that performs learning using a deep neural network (DNN) having a plurality of hidden layers and tends to improve in proportion to an amount of learning data. Here, learning processing of a large amount of data using a single processing device requires a long processing time. Therefore, in the recent years, distributed learning (DL) technology has been used. The distributed learning technology refers to technology in which learning is performed in parallel by distributing learning data to a plurality of local devices (nodes) and a central server acquires a learning model by aggregating learning results by the local devices. However, although distributed learning is performed, a learning result (a local parameter packet) of a local device is delivered to the central server. Therefore, if a plurality of local devices is present, a bottleneck situation occurs in the process of aggregating learning results, which may lead to increasing the overall learning time and an advantage of distributed processing may be diluted.

### SUMMARY

At least one example embodiment provides a learning processing system and a method of determining a number of local parameters that may prevent a degradation in a learning speed and may implement excellent learning performance.

To solve the aforementioned objective, a method of determining a number of local parameters, an apparatus for determining a number of local parameters, and a learning processing system are provided.

The number-of-local-parameters determination method may include receiving a number of local parameters less than or equal to a number of local parameters to be aggregated from at least one distributed learning processing apparatus; acquiring a T-th global parameter using the number of local parameters less than or equal to the number of local parameters to be aggregated; and updating or maintaining the number of local parameters to be aggregated depending on whether signs are different between a (T−1)-th global parameter and the T-th global parameter.

The number-of-local-parameters determination method may further include initializing the updated second counting result when the updated second counting result exceeds the predefined second reference value.

The number-of-local-parameters determination apparatus may include a communicator configured to receive a number of local parameters less than or equal to a number of local parameters to be aggregated from at least one distributed learning processing apparatus; and a processor configured to acquire a T-th global parameter using the number of local parameters less than or equal to the number of local parameters to be aggregated and to update or maintain the number of local parameters to be aggregated depending on whether signs are different between a (T−1)-th global parameter and the T-th global parameter.

A learning processing system may include at least one distributed learning processing apparatus configured to perform learning; and a number-of-local-parameters determination apparatus configured to receive a number of local parameters less than or equal to a number of local parameters to be aggregated from the at least one distributed learning processing apparatus based on a data plane, to acquire a T-th global parameter using the number of local parameters less than or equal to the number of local parameters to be aggregated, and to update or maintain the number of local parameters to be aggregated depending on whether signs are different between a (T−1)-th global parameter and the T-th global learning processing system, and apparatus and method for determining the number of local parameters.

According to the aforementioned learning processing system and number-of-local-parameters determination apparatus and method may improve learning performance without an excessive degradation in a learning speed.

Also, it is possible to prevent a decrease in a convergence speed of learning and to secure sufficient learning performance by receiving a local parameter from a plurality of distributed learning processing apparatuses (learning nodes) and by optimally determining a number of local parameters to be used.

Also, although a plurality of distributed learning processing apparatuses transmits local parameters, it is possible to appropriately implement a learning model without a bottleneck situation.

Also, by preferentially selecting first coming local parameters, it is possible to adaptively change a number of local parameters to be received even in an environment in which a straggler is present and to prevent a decrease in a learning speed by the straggler accordingly.

Also, even in an environment of performing programmable data plane (PDP)-based distributed learning, it is possible to reduce a number of network hops that traffic needs to pass through and also to reduce an amount of time used for aggregation and distribution of local parameters.

The aforementioned features and effects of the disclosure will be apparent from the following detailed description related to the accompanying drawings and accordingly those skilled in the art to which the disclosure pertains may easily implement the technical spirit of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an example of a learning processing system according to an example embodiment;

FIG. 2 is a block diagram illustrating an apparatus for determining a number of local parameters according to an example embodiment;

FIG. 3 is a first flowchart illustrating a method of determining a number of local parameters according to an example embodiment;

FIG. 4 is a second flowchart illustrating a method of determining a number of local parameters according to an example embodiment; and

FIG. 5 is a third flowchart illustrating a method of determining a number of local parameters according to an example embodiment.

### BEST MODE

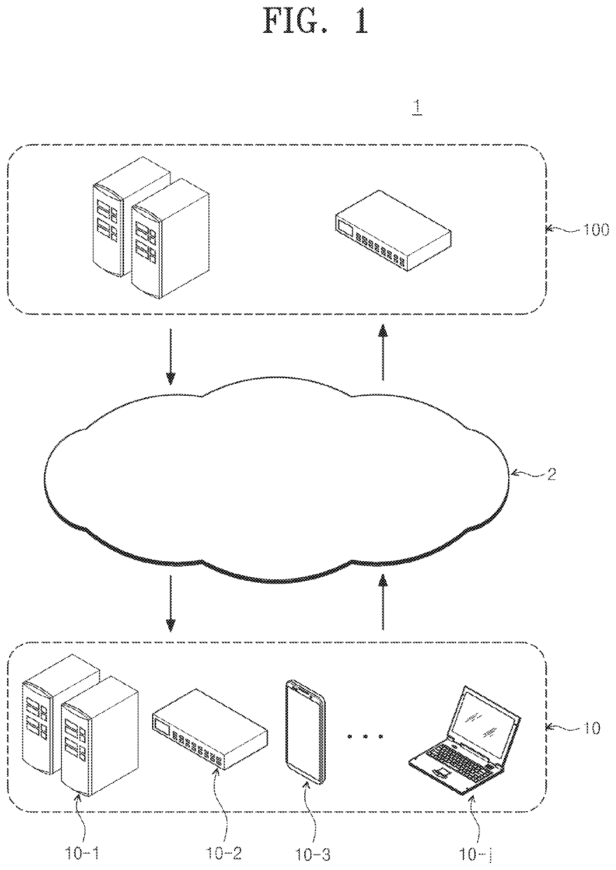

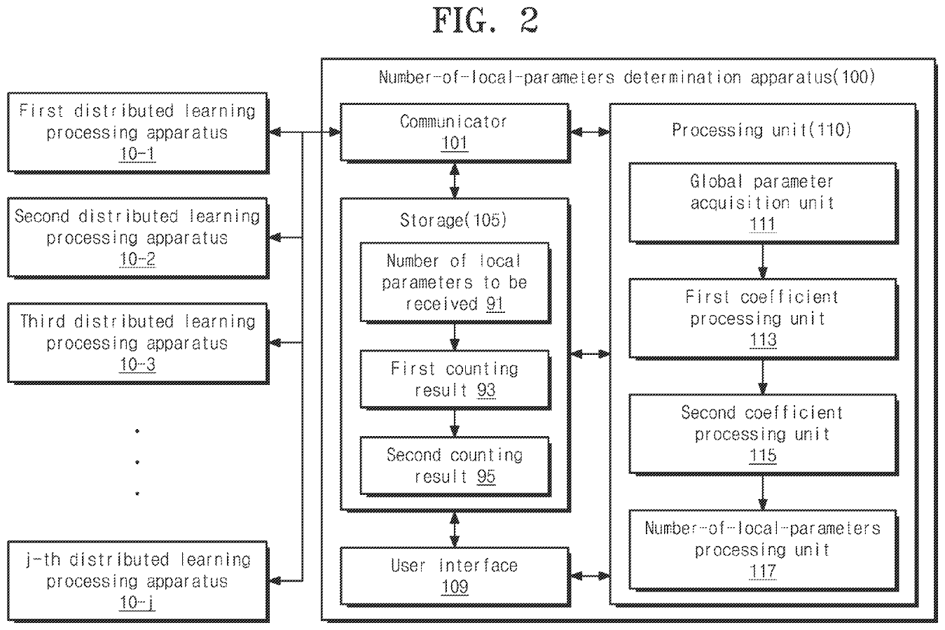

Hereinafter, example embodiments of an apparatus for determining a number of local parameters and a learning processing system including the same will be described with reference to FIGS. 1 and 2.

FIG. 1 illustrates a learning processing system according to an example embodiment.

A learning processing system 1 may include at least one distributed learning processing apparatus 10 (10-1 to 10-j) and an apparatus 100 for determining a number of at least one local parameter (hereinafter, a number-of-local-parameters determination apparatus) configured to aggregate a learning result of the at least one distributed learning processing apparatus 10 (10-1 to 10-j). The at least one distributed learning processing apparatus 10 (10-1 to 10-j) and the number-of-local-parameters determination apparatus 100 are provided to deliver data or an instruction through a communication network 2 in a one-way manner or in a two-way manner. Here, the communication network 2 may be constructed by including a wired communication network, a wireless communication network, or a combination thereof. The wireless communication network may include at least one a near field communication network and far field communication network. The near field communication network may include a network implemented based on communication technology, for example, wireless fidelity (Wi-Fi), Wi-Fi Direct, Bluetooth low energy (BLE), ultra-wideband (UWB) communication, radio frequency identification (RFID), ZigBee communication and NFD communication. The far field communication network may include a mobile communication network implemented based on a mobile communication standard, for example, 3^{rd} Generation Partnership Project (3GPP), 3GPP2, Wireless Broadband (WiBro), and World Interoperability for Microwave Access (WiMAX) series.

Each of the at least one distributed learning processing apparatus 10 (10-1 to 10-j) is configured to perform learning processing using at least one piece of data, may acquire a learning result, for example, a parameter (hereinafter, a local parameter, and which may include a weight and/or bias, etc.) according to learning processing, and to deliver the acquired local parameter to the number-of-local-parameters determination apparatus 100. Here, learning of each of the at least one distributed learning processing apparatus 10 (10-1 to 10-j) may be mutually independent or may be dependent. Here, at least one piece of data used by each of the at least one distributed learning processing apparatus 10 (10-1 to 10-j) may be all the same, may be partially the same, or may be all different. At least one piece of data may be directly input to each of the at least one distributed learning processing apparatus 10 (10-1 to 10-j) according to a user manipulation and may also be received from the number-of-local-parameters determination apparatus 100 or another apparatus (not shown, for example, a portable memory device, computer device, etc.). Also, each of the at least one distributed learning processing apparatus 10 (10-1 to 10-j) may receive the overall parameter (hereinafter, a global parameter) acquired by aggregating, by the number-of-local-parameters determination apparatus 100, at least one local parameter, may update a learning model using the global parameter, and then, may perform learning on at least one piece of data based on the updated learning model. The at least one distributed learning processing apparatus 10 (10-1 to 10-j) may repeatedly perform a series of operations, such as learning processing and generation and delivery of a local parameter, at least once.

The at least one distributed learning processing apparatus 10 (10-1 to 10-j) may store the learning model (a learning algorithm) required for learning processing and may perform learning processing using the learning model. The learning model may be acquired from the number-of-local-parameters determination apparatus 100, may be acquired from another apparatus (e.g., an external memory storage device, a server device, etc.), or may be acquired through a direct input from a designer or a user. Depending on example embodiments, the learning model of each of the at least one distributed learning processing apparatus 10 (10-1 to 10-j) may be all the same, may be partially same, or may be all different. Here, the learning model may include at least one of, for example, a deep neural network (DNN), a convolutional neural network (CNN), a deep belief network (DBN), a recurrent neural network (RNN), a convolutional recurrent neural network (CRNN), deep Q-networks, a long short term memory (LSTM), a multi-layer perceptron (MLP), a support vector machine (SVM), a generative adversarial network (GAN) and/or a conditional GAN (cGAN), but it is not limited thereto. The learning model may include at least one algorithm that may be considered by the designer to perform learning through training and to perform data processing based on a learning result, may include at least one program code created using the same or by including the same, or may include at least one program package based on all of or a portion of the program or implemented in whole or in part in combination.

At least one of the at least one distributed learning processing apparatus 10 (10-1 to 10-j) may be implemented using, alone or in combination, a device specially designed and produced to perform learning processing, and/or may be implemented using, alone or in combination, one or at least two information processing devices. Here, the one or the at least two information processing devices may include, for example, a desktop computer, a laptop computer, a hardware device for server, a tablet PC, a smartwatch, a smart tag, a smart band, a head mounted display (HMD) device, a handheld game console, a personal digital assistant (PDA), a navigation device, a remote controller, a digital television (TV), a set-top box, a digital media player device, an artificial intelligence (AI) sound playback device, home appliance (e.g., a refrigerator, a washing machine, etc.), a moving object (e.g., a vehicle such as a passenger vehicle, a bus, and a two-wheeled vehicle, an unmanned moving object such as a mobile robot, a wireless model vehicle, and a robot cleaner, etc.), a flying object (e.g., an aircraft, a helicopter, an unmanned aerial vehicle (a drone, etc.), etc.), a household, industrial, or military robot, industrial or military machine or machine facility, but are not limited thereto. In addition to the aforementioned information processing devices, various devices that may be considered by the designer or the user based on a situation or a condition may be used as the distributed learning processing apparatus 10 (10-1 to 10-j).

The number-of-local-parameters determination apparatus 100 may generate a global parameter for the learning model of each of first to j-th distributed learning processing apparatuses 10-1 to 10-j by receiving a local parameter acquired according to a learning result of each of the at least one distributed learning processing apparatus 10, for example, each of the first to j-th distributed learning processing apparatuses 10-1 to 10-j, from each of the first to j-th distributed learning processing apparatuses 10-1 to 10-j and by aggregating the received local parameters, and may perform distributed learning by delivering the generated global parameter to each of the first to j-th distributed learning processing apparatuses 10-1 to 10-j. In this case, as described above, each of the first to j-th distributed learning processing apparatuses 10-1 to 10-j may update the learning model using the received global parameter and then regenerate a local parameter, may deliver the regenerated local parameter to the number-of-local-parameters determination apparatus 100, and the number-of-local-parameters determination apparatus 100 may regenerate a global parameter using the received local parameter and may transmit the regenerated global parameter to each of the first to j-th distributed learning processing apparatuses 10-1 to 10-j. This process may be repeated. That is, the at least one distributed learning processing apparatus 10 (10-1 to 10-j) may perform a local parameter acquisition and delivery operation at least once and, in response thereto, the number-of-local-parameters determination apparatus 100 may perform a global parameter acquisition and broadcasting operation at least once.

In describing an operation of the number-of-local-parameters determination apparatus 100, a set of a series of operations (e.g., including learning processing, local parameter generation/delivery, global parameter generation/delivery, etc.) sequentially performed from the learning processing process of the at least one distributed learning processing apparatus 10 (10-1 to 10-j) to the global parameter delivery process of the number-of-local-parameters determination apparatus 100 is referred to as a single round. That is, in a single round, each of the at least one distributed learning processing apparatus 10 (10-1 to 10-j) acquires the local parameter and delivers the acquired local parameter to the number-of-local-parameters determination apparatus 100, and, in response thereto, the number-of-local-parameters determination apparatus 100 acquires the global parameter and delivers the acquired global parameter to each of the at least one distributed learning processing apparatus 10 (10-1 to 10-j). Each round may be repeatedly performed at least once by the at least one distributed learning processing apparatus 10 (10-1 to 10-j) and/or the number-of-local-parameters determination apparatus 100. The at least one round may be repeated until a point in time (e.g., a point in time at which performance of the learning model converges) predefined by the user or the designer.

FIG. 2 is a block diagram illustrating a number-of-local-parameters determination apparatus according to an example embodiment.

Referring to FIG. 2, the number-of-local-parameters determination apparatus 100 may determine a number of local parameters to be received (hereinafter, also, referred to as a number of local parameters to be aggregated) 91, and may acquire an overall parameter (i.e., a global parameter) for a learning model by synthesizing the collected local parameters according to the determined number of local parameters. For example, the number-of-local-parameters determination apparatus 100 may use the received local parameters to generate the global parameter when a total number of local parameters received until a corresponding point in time is less than or equal to or less than the set number of local parameters to be aggregated 91 and, on the contrary, may not use an additionally received local parameter to generate the global parameter when the total number of local parameters received until the corresponding point in time is greater than or greater than or equal to the number of local parameters to be aggregated 91.

Depending on example embodiments, the number-of-local-parameters determination apparatus 100 may be implemented using a device specially designed to perform the following processing and/or control, and/or may be implemented by using, alone or in combination, at least one information processing device. Here, the at least one information processing device may include, for example, at least one hardware device for network (e.g., a network switch (also, referable to as a switch or a switching hub), a computer device for server, etc.). When the number-of-local-parameters determination apparatus 100 is implemented using network equipment such as a network switch, the distributed learning processing apparatus 10 and the number-of-local-parameters determination apparatus 100 may perform distributed learning based on a programmable data plane. Also, the number-of-local-parameters determination apparatus 100 may be implemented using a desktop computer, a laptop computer, a smartphone, a tablet PC, a smart watch, a smart tag, a smart band, an HMD device, a handheld game console, a PDA, a navigation device, a remote controller, a digital TV, a set-top box, a digital media player device, an AI sound playback device, home appliance, a moving object, a flying object, a household, industrial, or military robot, industrial or military machine or machine facility.

However, without being limited to the examples, the number-of-local-parameters determination apparatus 100 may include at least one of various devices capable of processing and controlling information arbitrarily selectable by the designer or the user.

According to an example embodiment, the number-of-local-parameters determination apparatus 100 may include a communicator 101, a storage 105, a user interface 109, and a processing unit 110. At least two of the communicator 101, the storage 105, the user interface 109, and the processing unit 110 may be configured to deliver data or instruction/command and the like in a one-way manner or in a two-way manner through a cable or a circuitry. The storage 105 or the user interface 109 may be omitted if necessary.

The communicator 101 may connect to a wired communication network or a wireless communication network, may communicate with all of or a portion of the at least one distributed learning processing apparatus 10 (10-1 to 10-j), and may receive at least one local parameter from all of or a portion of the at least one distributed learning processing apparatus 10 (10-1 to 10-j). In this case, all of the local parameters received by the communicator 101 may be transmitted from different distributed learning processing apparatuses 10 (10-1 to 10-j) or may be transmitted from the same distributed learning processing apparatus 10 (10-1 to 10-j). Alternatively, a portion thereof may be transmitted from the same distributed learning processing apparatus 10 (10-1 to 10-j) and another portion thereof may be transmitted from different distributed learning processing apparatuses 10 (10-1 to 10-j). The at least one local parameter (e.g., first to M-th local parameters (M denotes a natural number of 1 or more) may be sequentially and/or simultaneously delivered to the communicator 101 depending on a situation. Also, the communicator 101 may deliver the global parameter to the at least one distributed learning processing apparatus 10 (10-1 to 10-j). If necessary, the communicator 101 may further receive data (e.g., the number of local parameters to be aggregated 91), a program (referable to as an app, software, or an application), an instruction/command, and the like required for an operation of the processing unit 110, or may transmit required data (e.g., the number of local parameters to be aggregated 91), a program, or an instruction/command, and the like, to another distributed learning processing apparatus 10 (10-1 to 10-j). The communicator 101 may be implemented using a communication port (or an antenna) or related circuit part (e.g., a communication chip). The data (e.g., at least one local parameter) received by the communicator 101 may be delivered to at least one of the storage 105 and the processing unit 110.

The storage 105 may transitorily or non-transitorily store at least one piece of data and may transitorily or non-transitorily store, for example, information required for an operation of the processing unit 110 or various types of processing results acquired according to processing of the processing unit 110. In detail, for example, the storage 105 may store at least one local parameter or the generated global parameter, and may store a counting result (hereinafter, a first counting result) 93 acquired by counting a number of cases in which signs are different between the number of local parameters to be aggregated 91 determined by the processing unit 110 or a global parameter (hereinafter, a T-th global parameter (T=natural number of 2 or more) newly acquired in a current processing round (e.g., learning processing, a local parameter delivery, and a global parameter acquisition process, etc.) and a global parameter (hereinafter, a (T−1)-th global parameter) acquired in the existing processing round (e.g., an immediately previous processing round), a result (hereinafter, a second counting result) 95 acquired by counting a comparison result between the first counting result 93 and a predetermined reference value (hereinafter, a first reference value), and the like. The storage 105 may also store a program for an operation of the processing unit 110. Here, the program may be directly input or modified by the designer or the user, and may be input through the communicator 101 or the user interface 109 and then stored or updated. Also, the storage 105 may store information for identifying the at least one distributed learning processing apparatus 10 (10-1 to 10-j) or a setting value for a learning model to be used for learning or generation of the global parameter. The storage 105 may include at least one of a main memory device and an auxiliary memory device. The main memory device may be implemented using, for example, a semiconductor storage device, such as read only memory (ROM) and random access memory (RAM). The auxiliary memory device may be implemented using, for example, a flash memory device, a secure digital (SD) card, a solid state drive (SSD), optical media such as a hard disk drive (HDD), a magnetic drum, a compact disk (CD), a DVD, or a laser disk, and a storage medium such as a magnetic tape, an optical disk or a floppy disk.

The user interface 109 is configured to receive data, a program, an instruction/command, or other information from the designer, the user, or another device, and/or to deliver the same to the designer, the user, or another device. For example, the user interface 109 may receive a threshold (hereinafter, a second reference value) used for comparison with the second counting result 95 from the designer or the user, or may visually or auditorily provide the determined number of local parameters or global parameter to the designer or the user. Depending on example embodiments, the user interface 109 may include at least one of an input unit configured to receive a command or data from the user and an output unit configured to visually or auditorily provide data to the user. Here, the input unit may include, for example, a keyboard, a mouse, a tablet, a touchscreen, a touch pad, a track ball, a track pad, a scanner device, an image capturing module, an ultrasound scanner, a motion sensor, a vibration sensor, a light receiving sensor, a pressure sensor, a proximity sensor, a microphone, and/or a data I/O terminal. The output unit may include a display, a printer device, a speaker device, an image output terminal, and/or a data I/O terminal. The input unit and the output unit may be integrally implemented depending on example embodiments.

Depending on example embodiments, the user interface 109 may be provided integrally with the number-of-local-parameters determination apparatus 100 or may be provided to be physically separable.

The processing unit 110 may perform an operation of determining the number of local parameters to be aggregated 91 and may further perform an operation of generating a global parameter depending on example embodiments. The processing unit 110 may execute the program stored in the storage 105 and/or may perform an operation of determining the number of local parameters to be aggregated 91 or an operation of generating a global parameter in response to an instruction from an external processing device (e.g., a central parameter server (PS)). The processing unit 110 may be implemented by using, alone or in combination, for example, at least one chipset, a central processing unit (CPU), a micro controller unit (MCU), an application processor (AP), an electronic controlling unit (ECU), a baseboard management controller (BMC), a Micro Processor (Micom) and/or at least one electronic device capable of performing various types of operations and control processing. Such processing or a control device may be implemented by using, alone or in combination, one or at least two semiconductor chips, circuits, or related parts.

According to an example embodiment, referring to FIG. 2, the processing unit 110 may include a global parameter acquisition unit 111, a first coefficient processing unit 113, a second coefficient processing unit 115, and a number-of-local-parameters processing unit 117. At least two of the global parameter acquisition unit 111, the first coefficient processing unit 113, the second coefficient processing unit 115, and the number-of-local-parameters processing unit 117 may be logically separated or may be physically separated. In the case of being logically separated, the global parameter acquisition unit 111, the first coefficient processing unit 113, the second coefficient processing unit 115, and the number-of-local-parameters processing unit 117 may be implemented by a single semiconductor processing device. In the case of being physically separated, at least two of the global parameter acquisition unit 111, the first coefficient processing unit 113, the second coefficient processing unit 115, and a number-of-local-parameters processing unit 117 may be implemented by at least two separate semiconductor processing devices.

The global parameter acquisition unit 111 may acquire the number of local parameters to be aggregated 91 from the storage 105 or the number-of-local-parameters processing unit 117. The number of local parameters to be aggregated 91 may be determined by the number-of-local-parameters processing unit 117 or may be input from the user or the designer. If a value of the number of local parameters to be aggregated 91 is not determined or is given as a value of 0 and the like, the global parameter acquisition unit 111 may initialize the number of local parameters to be aggregated 91 by setting the same to a predetermined basic value (e.g., 1). The global parameter acquisition unit 111 may acquire a global parameter based on at least one local parameter transmitted form each distributed learning processing apparatus 10. For example, when the communicator 101 receives a packet in which the at least one local parameter is recorded from each distributed learning processing apparatus 10 (10-1 to 10-j), the communicator 101 may extract the at least one local parameter from the packet in receive order or in arbitrary order and may acquire the global parameter using the extracted at least one local parameter. In this case, the global parameter acquisition unit 111 may acquire the global parameter by summing or weighted-summing the at least one local parameter. Evert time a local parameter is received, the global parameter acquisition unit 111 may also receive or update the global parameter. For example, when the local parameter is received, the global parameter acquisition unit 111 may acquire or update the global parameter by performing an operation, such as a summation or a weighted summation of a newly received local parameter for the global parameter that is acquired or updated through summation or a weighted summation of the existing received local parameters.

According to an example embodiment, the global parameter acquisition unit 111 may also acquire the global parameter according to the number of local parameters to be aggregated 91. In more detail, the global parameter acquisition unit 111 may also acquire the global parameter using a number of local parameters equal to the number of local parameters to be aggregated 91 or less than the number of local parameters to be aggregated 91. For example, the global parameter acquisition unit 111 may count a number of local parameters received and, when a counting result (i.e., a number of received local parameters) is less than the number of local parameters to be aggregated 91, a corresponding local parameter may be added to the global parameter acquired before the corresponding point in time. On the contrary, when the counting result is greater than the number of local parameters to be aggregated 91, the global parameter may be calculated by not adding the received local parameter. The local parameter that is not used for an operation of the global parameter is ignored. When the number of local parameters to be aggregated 91 is the same as the counting result, a local parameter at a corresponding point in time may be added and thereby summed to the calculated global parameter or may be ignored. That is, when the number of local parameters to be aggregated 91 is set to N (N=natural number greater than 1 and less than M), a first local parameter to an N-th local parameter (or an (N−1)-th local parameter depending on example embodiments) that initially arrive at the number-of-local-parameters determination apparatus 100 may be used for an operation of the global parameter and a subsequently arrived (N+1)-th local parameter (depending on example embodiments, an N-th local parameter) to an M-th local parameter may not be used for an operation of the global parameter. Therefore, the global parameter may be calculated using a number of local parameters less than or equal to (or less than) the acquired number of local parameters to be aggregated 91. An operation process of the global parameter may be finally expressed as, for example, the following Equation 1.

$${g}_{G}^{t} = {\sum }_{n = 1}^{N} {g}_{n , L}^{t} \qquad [ Equation 1 ]$$

In Equation 1, N denotes the number of local parameters to be aggregated 91, t denotes an index number that represents a corresponding local and global parameter acquisition process (a corresponding round), g\hat{ }\hat{ }t_n,L denotes a local parameter received at a point in time of n, and g\hat{ }t_G denotes a final global parameter acquired by sequentially summing received local parameters (i.e., N local parameters) of the received number of local parameters to be aggregated 91.

The global parameter (e.g., a global parameter or a final global parameter calculated and acquired every time a local parameter is received) may be delivered to each distributed learning processing apparatus 10 (10-1 to 10-j) immediately, after elapse of a desired period of time, or after predetermined processing.

According to an example embodiment, the global parameter acquisition unit 111 may be configured to determine whether a packet received before acquiring a global parameter is a packet that includes a local parameter. In this case, if the local parameter is extractable from the received packet, the global parameter acquisition unit 111 may acquire a global parameter as described above. If the local parameter is not extractable from the packet due to absence of the local parameter in the received packet, the global parameter acquisition unit 111 does not use the received packet for generating or updating the global parameter. The packet in which the local parameter is absent may be processed using the same method as or a method different from that of other general packet(s) by the processing unit 110. Determination related to whether the local parameter is included in the packet and processing according thereto may be omitted.

According to another example embodiment, the global parameter acquisition unit 111 may determine whether a global parameter is broadcasted to all of or a portion of the at least one distributed learning processing apparatus 10 (10-1 to 10-j) before an operation of the global parameter. If the global parameter is already transmitted to all of the at least one distributed learning processing apparatus 10 (10-1 to 10-j) or a portion of the at least one distributed learning processing apparatus 10 (10-1 to 10-j), the global parameter acquisition unit 111 may not perform the aforementioned global parameter generation operation depending on example embodiments. In this case, the global parameter acquisition unit 111 may ignore local parameters being received and may not perform processing of the local parameters (e.g., generation of the global parameter). Determination related to whether the global parameter is already transmitted and related processing may be omitted.

As described above, the acquired global parameter (or each value(s) included in the global parameter) may have a value of zero (0), a positive value, or a negative value according to summed local parameters. The first coefficient processing unit 113 may determine whether signs are identical between a global parameter (a T-th global parameter) acquired in a current round (e.g., a T-th round) and a global parameter (a (T−1)-th global parameter) acquired in an existing round (e.g., a (T−1)-th round just before the T-th round) and may acquire or update the first counting result 93 based on a determination result. For example, the first coefficient processing unit 113 may update the first counting result 93 by counting a number of cases in which signs are different between the T-th global parameter and the (T−1)-th global parameter. In detail, the first coefficient processing unit 113 may extract a sign value of the acquired T-th global parameter (e.g., a 1-bit value stored as 1 for a positive number and stored as 0 for a negative number), may acquire at least one bit string (S\hat{ }t_G) corresponding to the extracted sign value, and may perform an exclusive OR (XOR) operation on at least one bit string (S\hat{ }t_G) corresponding to the sign value of the T-th global parameter and at least one bit string (S\hat{ }(t−1)_G) corresponding to the sign value of the existing extracted (T−1)-th global parameter and may acquire a bit string (R\hat{ }t_G) corresponding to an XOR operation result and then, may generate the first counting result 93 by counting a number of cases in which a value of the bit string (R\hat{ }t_G) is 1 or may update the first counting result 93 using a method of adding a result of counting the number of cases in which the value of the bit string (R\hat{ }t_G) is 1 to the acquired first counting result 93. The XOR operation returns 0 for the same operation target and returns 1 for a different operation target. Therefore, when signs of both global parameters are different, a value of the bit string (R\hat{ }t_G) corresponding to the operation result is given as 1. Therefore, in the case of summing a value of each bit string (R\hat{ }t_G) corresponding to the operation result, it is possible to count a number of cases in which a sign of a final global parameter newly acquired in one process is changed to differ from that of a final global parameter acquired in a previous process.

The second coefficient processing unit 115 may compare a case in which signs are different between the T-th global parameter and the (T−1)-th global parameter to a predetermined value (i.e., a first reference value) and may determine a value (the second counting result 95) according to a comparison result. In detail, the second coefficient processing unit 115 may receive the first counting result 93 from the first coefficient processing unit 113, may compare the first counting result 93 to the first reference value, and may update or maintain the second counting result 95 according to a comparison result. For example, when the corresponding global parameter acquisition process is terminated, the second coefficient processing unit 115 may compare the first counting result 93 and the first reference value. If the first counting result 93 is greater than the first reference value, the second coefficient processing unit 115 may update the second counting result 95 by applying a predetermined value (e.g., 1) to the initial or existing updated second counting result 95 and otherwise, may maintain the existing second counting result 95 as is, thereby acquiring, updating, or maintaining the second counting result 95. When the existing second counting result 95 is maintained (i.e., if the first counting result 93 is less than the first reference value), the T-th global parameter may be delivered to each distributed learning processing apparatus 10 (10-1 to 10-j) depending on example embodiments. Here, that the corresponding global parameter acquisition process is terminated may include, for example, that a local parameter packet received from the at least one distributed learning processing apparatus 10 (10-1 to 10-j) is a last local parameter packet to be received in a corresponding round. Meanwhile, if the received local parameter packet is not the last local parameter packet to be received in the corresponding round, the acquired T-th global parameter may be broadcasted and delivered to each distributed learning processing apparatus 10 (10-1 to 10-j). Also, the first reference value may be predefined by the user or the designer. For example, the first reference value may include a half (i.e., ½) of a total number of parameters for the entire model, but is not limited thereto. As another example, the designer may define the first reference value as two-thirds of the total number of parameters, if necessary. As described above, since the first counting result 93 is acquired by counting a number of cases in which signs are different between the T-th global parameter and the (T−1)-th global parameter, the second counting result 95 represents a number of cases in which a number of global parameters each of which a sign is different from a sign of a previous global parameter (i.e., a case in which signs are different between two consecutive global parameters) in a process of acquiring the first global parameter to the T-th global parameter is greater than a predetermined criterion (i.e., the first reference value).

The number-of-local-parameters processing unit 117 may receive the generated or updated second counting result 95 form the second coefficient processing unit 115 and may determine the number of local parameters to be aggregated 91 based on the generated or updated second counting result 95. In detail, for example, the number-of-local-parameters processing unit 117 may compare the second counting result 95 to the predefined second reference value and, if the second counting result 95 is less than the second reference value, may maintain the number of local parameters to be aggregated 91 as is. On the contrary, if the second counting result 95 is greater than the second reference value, the number-of-local-parameters processing unit 117 may increase and update the number of local parameters to be aggregated 91. In this case, the number-of-local-parameters processing unit 117 may newly determine and update the number of local parameters to be aggregated 91 by summing a predetermined value (e.g., 1) to the existing number of local parameters to be aggregated 91. The second reference value may be arbitrarily defined by the user or the designer. Also, when the number of local parameters to be aggregated 91 is newly determined, the number-of-local-parameters processing unit 117 may initialize the updated second counting result 95 to a predetermined value (e.g., 0) in response thereto. According to the aforementioned processing, the number of local parameters to be aggregated 91 may be appropriately updated with a new value. The global parameter acquisition unit 111 may acquire again an appropriate number of local parameters based on the updated new number of local parameters to be aggregated 91 and may determine again the global parameter using the same. For example, if the second counting result 95 is greater than the second reference value, the global parameter acquisition unit 111 may generate or update the global parameter based on a larger number of local parameters (e.g., N+1) than before. Conversely, if the second counting result 95 is less than the second reference value, the global parameter acquisition unit 111 generates or updates the global parameter based on the same number of local parameters (e.g., N) as before.

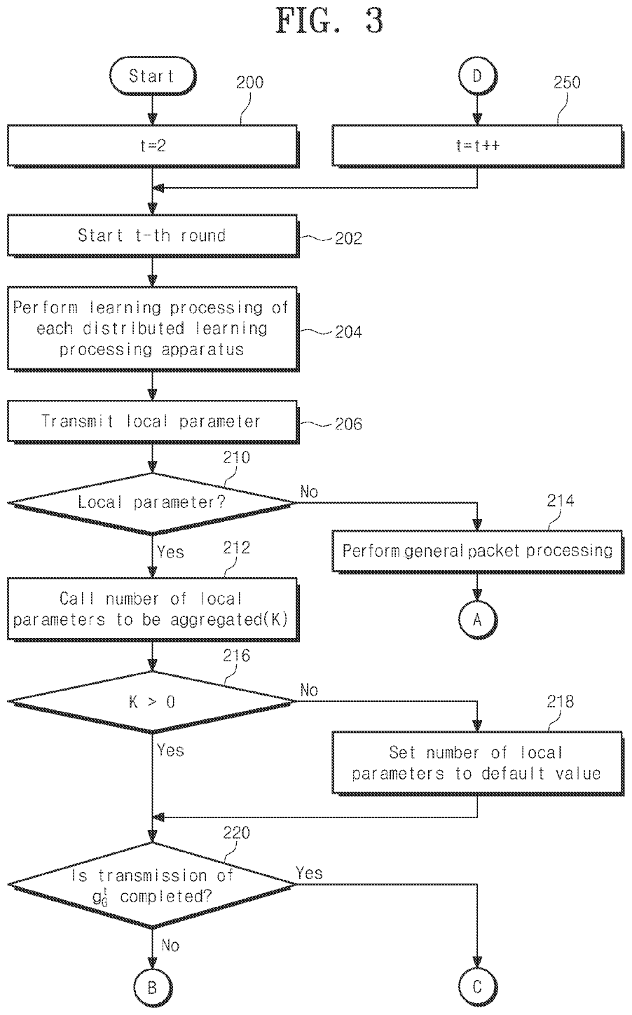

Hereinafter, some example embodiments of a method of determining a number of local parameters are described with reference to FIGS. 3 to 5.

FIGS. 3 to 5 are first to third flowcharts illustrating a method of determining a number of local parameters according to an example embodiment.

Referring to FIGS. 3 to 5, in operations 200 and 202, a t-th round (e.g., a second round) is started.

When any one round is started, each of at least one distributed learning processing apparatus may train a predetermined learning model using data and may acquire a local parameter according to a training result in operation 204. Here, the learning model trained by each distributed learning processing apparatus may be all the same, may be partially different, or may be all different. Also, data used by each distributed learning processing apparatus may be all the same or may be all different. Alternatively, some may be the same and others may be different.

When the local parameter is acquired, each distributed learning processing apparatus may transmit the local parameter to a number-of-local-parameters determination apparatus connected to a wired or wireless communication network immediately or after a predetermined period of time in operation 206. Here, the number-of-local-parameters determination apparatus may be implemented, alone or in combination, a device and/or at least one information processing device specially designed to determine the number of local parameters.

According to an example embodiment, the number-of-local-parameters determination apparatus may be implemented using, for example, a hardware device for network such as a network switch and a computer device for server. In this case, the distributed learning processing apparatus and the number-of-local-parameters determination apparatus may perform predetermined data transmission or processing based on a programmable data plane.

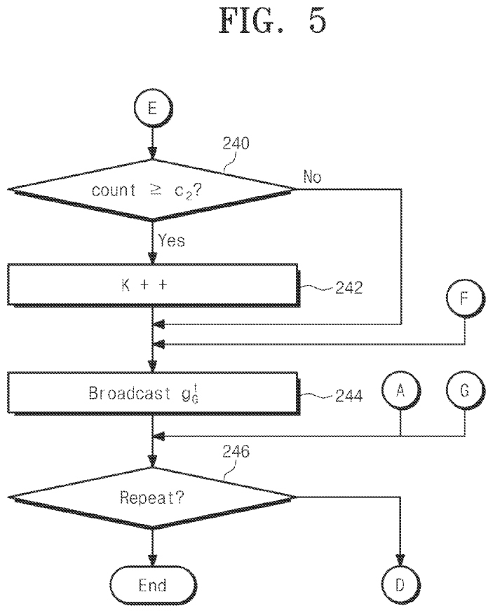

In operation 210, the number-of-local-parameters determination apparatus may initially determine whether a packet received from the distributed learning processing apparatus includes the local parameter. When the received packet does not include the local parameter (no in operation 210), general packet processing is performed for the received packet in operation 214. Then, depending on whether repetition is performed in operation 246 of FIG. 5, a subsequent round (e.g., a second round) is started (yes in operation 246) in operations 250 and 202 or the entire processing process is terminated (no in operation 246). On the contrary, when the received packet includes the local parameter (yes in operation 210), the number-of-local-parameters determination apparatus may acquire a number of local parameters to be aggregated (K) in operation 212. The number of local parameters to be aggregated (K) may be stored in, for example, a storage such as a main memory device and an auxiliary memory device. Operation 210 of determining whether the received packet includes the local parameter may be omitted if necessary. In this case, when the local parameter is received in operation 206, the number-of-local-parameters determination apparatus may acquire the number of local parameters to be aggregated (K) in response thereto in operation 212.

Depending on example embodiments, the number-of-local-parameters determination apparatus may determine whether the acquired number of local parameters to be aggregated (K) is greater than 0 in operation 216. Unless the acquired number of local parameters to be aggregated(K) is a value (e.g., a natural number) that exceeds 0 (no in operation 216), the number of local parameters may be set to a predetermined default value (e.g., 1) in operation 218.

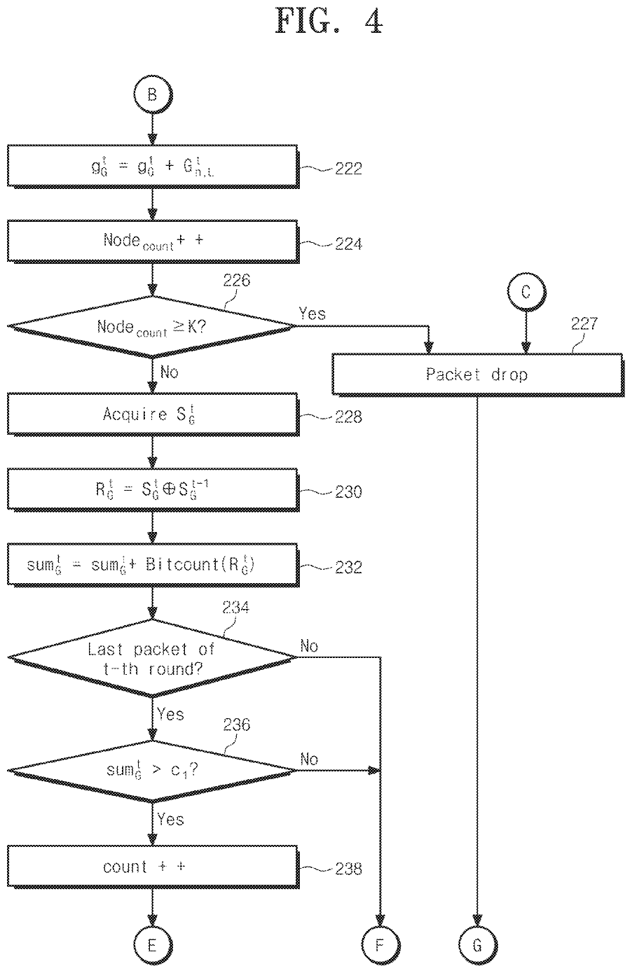

If the number of local parameters to be aggregated (K) is greater than 0 (yes in operation 216) or is initialized to a default value such as 1 in operation 218, the number-of-local-parameters determination apparatus may further determine whether a global parameter (g\hat{ }t_G) is transmitted to each distributed learning processing apparatus in operation 220, depending on example embodiments. If transmission (broadcasting) of the global parameter (g\hat{ }t_G) is completed (yes in operation 220), the number-of-local-parameters determination apparatus may ignore a subsequently received packet (that may include or may not include the local parameter) and may not perform processing thereof in operation 227 as illustrated in FIG. 4. On the contrary, unless transmission of the global parameter (g\hat{ }t_G) is completed (no in operation 220), the number-of-local-parameters determination apparatus may generate or update the global parameter (g\hat{ }t_G) in operation 222 as illustrated in FIG. 4. Here, operation 220 of determining whether the global parameter (g\hat{ }t_G) is transmitted may be omitted.

According to an example embodiment, the number-of-local-parameters determination apparatus may update the global parameter (g\hat{ }t_G) by summing or weighted-summing a newly delivered local parameter (g\hat{ }t_n,L) to a previously calculated global parameter (g\hat{ }t_G) in operation 222. If the previously calculated global parameter (g\hat{ }t_G) is 0 (e.g., if the existing acquired global parameter (g\hat{ }t_G) is absent), the newly delivered local parameter (G\hat{ }t_n,L) may be used as is or partially deformed and thereby used as the global parameter (g\hat{ }t_G).

Simultaneously or sequentially with operation 222 of adding the local parameter (G\hat{ }t_n,L) to the previously calculated global parameter (g\hat{ }t_G), the received local parameter (G\hat{ }t_n,L) may be counted in operation 224. Operation 224 of counting the received local parameter (G\hat{ }t_n,L) may be performed by adding 1 to a variable (Node_count) that represents a number of received local parameters (G\hat{ }t_n,L). The variable (Node_count) that represents the number of received local parameters (G\hat{ }t_n,L) may be provided to increase by 1 whenever the local parameter is received and acquired.

In operation 226, the number-of-local-parameters determination apparatus may compare a counting result of the received local parameter (G\hat{ }t_n,L) (e.g., the variable (Node_count) that represents the number of received local parameters (G\hat{ }t_n,L)) and the previously called number of local parameters to be aggregated (K). If a counting result of the received local parameter (G\hat{ }t_n,L) is greater than the number of local parameters to be aggregated (K) or equal thereto depending on example embodiments (yes in operation 226), subsequent packets delivered from each distributed learning processing apparatus may be ignored and may not be processed in operation 227.

On the contrary, if the counting result of the received local parameter (G\hat{ }t_n,L) is less than the number of local parameters to be aggregated (K), the number-of-local-parameters determination apparatus may extract a sign value of the global parameter and may acquire at least one bit string (S\hat{ }t_G) corresponding to the sign value in operation 228. For example, the number-of-local-parameters determination apparatus may call, from the global parameter, a value of an area (e.g., a 1-bit storage space stored as 1 for a positive number and stored as 0 for a negative number) that represents a sign and may acquire at least one bit string (S\hat{ }t_G) corresponding to the sign value.

In operations 230 and 232, the number-of-local-parameters determination apparatus may acquire at least one bit string (S\hat{ }(t−1)_G) corresponding to a sign value of a previous round (i.e., a (t−1)-th round, for example, a first round), may perform an XOR operation using at least one bit string (S\hat{ }t_G) corresponding to a sign value of a global parameter (g\hat{ }t_G) acquired in a current round (i.e., a second round) and at least one bit string (S\hat{ }(t−1)_G) corresponding to a sign value of the global parameter (g\hat{ }(t−1)_G) acquired in the previous round (i.e., the first round), and may acquire or update the first counting result (sum\hat{ }t_G). In detail, for example, the number-of-local-parameters determination apparatus may update the first counting result (sum\hat{ }t_G) by acquiring the bit string (R\hat{ }t_G) according to the XOR operation result in operation 230 and by counting a number of cases in which a value of the bit string (R\hat{ }t_G) is 1 and then adding a counting result (Bitcount(R\hat{ }t_G)) to the first counting result (sum\hat{ }t_G), or may determine and acquire the counting result (Bitcount(R\hat{ }t_G)) as the first counting result (sum\hat{ }t_G) as is in operation 232.

According to an example embodiment, the number-of-local-parameters determination apparatus may further determine whether the received packet is a last packet of a corresponding round (e.g., the second round) in operation 234. Unless the received packet is a last local parameter packet of the corresponding round (no in operation 234), the global parameter (g\hat{ }t_G) may be broadcasted and thereby delivered to each distributed learning processing apparatus in operation 244 as illustrated in FIG. 5.

In operation 236, the first counting result (sum\hat{ }t_G) may be compared to the predefined first reference value (c_1). If the first counting result (sum\hat{ }t_G) is less than the predefined first reference value (c_1) (no in operation 236), the acquired global parameter (g\hat{ }t_G) of the corresponding round (e.g., the second round) may be delivered to each distributed learning processing apparatus as illustrated in FIG. 5 in operation 244. If the first counting result (sum\hat{ }t_G) is greater than the predefined first reference value (c_1) (yes in operation 236), the second counting result (count) may be set or updated in operation 238. For example, if the first counting result (sum\hat{ }t_G) is greater than the predefined first reference value (c_1) (yes in operation 236), the second counting result (count) may be updated by adding a value of 1 to the existing second counting result (count).

Referring to FIG. 5, when the second counting result (count) is acquired or updated in operation 238 of FIG. 4, the second counting result (count) may be compared to a second reference value (c_2) in operation 240. If the second counting result (count) is greater than the second reference value (c_2) (yes in operation 240 and, depending on example embodiments, including a case in which the second counting result (count) is equal to the second reference value (c_2)), the number of local parameters to be aggregated (K) may be updated in operation 242. For example, the number of local parameters to be aggregated (K) may be updated by adding 1 to the existing number of local parameters to be aggregated (K). The updated number of local parameters to be aggregated (K) may be transitorily or non-transitorily stored in the storage. If the second counting result (count) is less than the second reference value (c_2) (no in operation 240), updating of the number of local parameters to be aggregated (K) is not performed.

In operation 244, the global parameter (g\hat{ }t_G) acquired in the corresponding round (e.g., the second round) may be simultaneously or sequentially delivered to each distributed learning processing apparatus.

Through operations 246 and 250, the aforementioned process (operations 202 to 244) may be repeatedly performed if necessary. That is, once the corresponding round (e.g., the second round) is terminated, a subsequent round (e.g., a third round) may be started according to a situation. Performing and processing of a round may be repeatedly performed until, for example, performance of the learning model is appropriately converged.

The aforementioned process (operations 200 to 246) may be performed in order different from the example illustrated in FIGS. 3 to 5 depending on example embodiments. For example, operation 220 of determining whether the global parameter (g\hat{ }t_G) is transmitted may be performed before operation 212 of calling and acquiring the number of local parameters to be aggregated (K). Also, as another example, operation 224 of counting the number of received local parameters (G\hat{ }t_n,L) may be performed before operation 222 of generating or updating the global parameter (g\hat{ }t_G). In addition thereto, each of operations 200 to 246 may be processed in order different from the above according to an arbitrary selection from the designer or the user.

The number-of-local parameters determination method according to the example embodiments may be implemented in a form of a program executable by a computer device. The program may include, alone or in combination with instructions, libraries, data files, and/or data structures. The program may be designed and produced using a machine language code or a high-level language code. The program may be specially designed to implement the aforementioned methods and may be implemented using various types of functions or definitions known and available to those skilled in the art in the computer software arts. Also, here, the computer device may be implemented by including a processor or a memory that enables functions of the program and, if necessary, may further include a communication apparatus. Also, the program to implement the number-of-local parameters determination method may be recorded in non-transitory computer-readable recording media. The media may include, for example, a semiconductor storage device such as a solid state drive (SSD), read only memory (ROM), read access memory (RAM), and a flash memory, magnetic disk storage media such as hard disks and floppy disks, optical media such as compact discs and DVDs, magneto-optical media such as floptical disks, and at least one physical device configured to store a specific program executed according to a call of a computer and the like, such as magnetic tapes.

Although example embodiments of the learning processing system, the number-of-local parameters determination apparatus, and the number-of-local parameters determination method are described, the learning processing system, the number-of-local parameters determination apparatus, or the number-of-local parameters determination method is not limited to the aforementioned example embodiments. Various apparatuses or methods implemented by those skilled in the art through modifications and alterations based on the aforementioned example embodiments also belong to an example embodiment of the learning processing system, the number-of-local parameters determination apparatus, or the number-of-local parameters determination method. For example, although the aforementioned method(s) are performed in order different from the aforementioned description and/or component(s), such as systems, structures, apparatuses, and circuits, are coupled, connected, or combined in a different form or replaced or substituted with another component or equivalent, it may also correspond to at least one example embodiment of the aforementioned learning processing system, number-of-local parameters determination apparatus, and number-of-local parameters determination method.

What is claimed is:

1. A method of determining a number of local parameters, the method comprising:
receiving a number of local parameters less than or equal to a number of local parameters to be aggregated from at least one distributed learning processing apparatus;
acquiring a T-th global parameter using the number of local parameters less than or equal to the number of local parameters to be aggregated; and
updating or maintaining the number of local parameters to be aggregated depending on whether signs are different between a (T−1)-th global parameter and the T-th global parameter.

2. The method of claim 1, wherein the updating or the maintaining the number of local parameters to be aggregated depending on whether the signs are different between the (T−1)-th global parameter and the T-th global parameter comprises:
acquiring a first counting result by counting a number of cases in which the signs are different between the T-th global parameter and (T−1)-th global parameter; and
comparing the first counting result and a first reference value and updating or maintaining the number of local parameters to be aggregated according to a comparison result.

3. The method of claim 2, wherein the comparing the first counting result and first reference value and the updating or the maintaining the number of local parameters to be aggregated according to the comparison result comprises:
updating a second counting result when the first counting result exceeds the first reference value; and
increasing and thereby updating the number of local parameters to be aggregated when the updated second counting result exceeds a predefined second reference value.

4. The method of claim 3, wherein the second counting result is acquired based on the comparison result between the first counting result between two consecutive global parameters among a first global parameter to the (T−1)-th global parameter and the first reference value.

5. The method of claim 3, further comprising:
initializing the updated second counting result when the updated second counting result exceeds the predefined second reference value.

6. The method of claim 2, wherein the first reference value includes a half of a total number of parameters.

7. The method of claim 2, wherein the acquiring the first counting result by counting the number of cases in which the signs are different between the T-th global parameter and the (T−1)-th global parameter comprises:
performing an exclusive OR (XOR) operation between a sign value of the T-th global parameter and a sign value of the (T−1)-th global parameter; and
acquiring the first counting result by summing results of the XOR operation or by counting a number of results with a value of 1 among the results of the XOR operation.

8. The method of claim 1, further comprising:
delivering the T-th global parameter to the at least one distributed learning processing apparatus.

9. An apparatus for determining a number of local parameters, the apparatus comprising:
a communicator configured to receive a number of local parameters less than or equal to a number of local parameters to be aggregated from at least one distributed learning processing apparatus; and
a processor configured to acquire a T-th global parameter using the number of local parameters less than or equal to the number of local parameters to be aggregated and to update or maintain the number of local parameters to be aggregated depending on whether signs are different between a (T−1)-th global parameter and the T-th global parameter.

10. The apparatus of claim 9, wherein the processor is configured to acquire a first counting result by counting a number of cases in which the signs are different between the T-th global parameter and (T−1)-th global parameter, and to compare the first counting result and a first reference value and to update or maintain the number of local parameters to be aggregated according to a comparison result.

11. The apparatus of claim 10, wherein the processor is configured to update a second counting result and acquire the updated second counting result when the first counting result exceeds the first reference value, and to increase the number of local parameters to be aggregated and update the number of local parameters to be aggregated when the updated second counting result exceeds a predefined second reference value.

12. The apparatus of claim 11, wherein the second counting result is acquired based on the comparison result between the first counting result between two consecutive global parameters among a first global parameter to the (T−1)-th global parameter and the first reference value.

13. The apparatus of claim 12, wherein the processor is configured to initialize the updated second counting result when the updated second counting result exceeds the predefined second reference value.

14. The apparatus of claim 10, wherein the first reference value includes a half of a total number of parameters.

15. The apparatus of claim 10, wherein the processor is configured to perform an exclusive OR (XOR) operation between a sign value of the T-th global parameter and a sign value of the (T−1)-th global parameter and to acquire the first counting result by summing results of the XOR operation or by counting a number of results with a value of 1 among the results of the XOR operation.

16. The apparatus of claim 9, wherein the communicator is configured to deliver the T-th global parameter to the at least one distributed learning processing apparatus.

17. A learning processing system comprising:
at least one distributed learning processing apparatus configured to perform learning; and
a number-of-local-parameters determination apparatus configured to receive a number of local parameters less than or equal to a number of local parameters to be aggregated from the at least one distributed learning processing apparatus based on a data plane, to acquire a T-th global parameter using the number of local parameters less than or equal to the number of local parameters to be aggregated, and to update or maintain the number of local parameters to be aggregated depending on whether signs are different between a (T−1)-th global parameter and the T-th global parameter.
